(19) United States
(12) Patent Application Publication
(10) Pub. No.: US 2015/0012699 A1
(43) Pub. Date: Jan. 8, 2015

(54) SYSTEM AND METHOD OF VERSIONING CACHE FOR A CLUSTERING TOPOLOGY

(71) Applicant: LSI Corporation, San Jose, TX (US)

(72) Inventors: James A. Rizzo, Austin, TX (US); Rajsekhar Chundru, San Jose, CA (US); Vinu Velayudhan, Milpitas, CA (US); Adam Weiner, Henderson, NV (US)

(21) Appl. No.: 13/939,214

(22) Filed: Jul. 11, 2013

Related U.S. Application Data
(60) Provisional application No. 61/842,196, filed on Jul. 2, 2013.

(51) Int. Cl. G06F 12/08

(52) U.S. Cl. CPC G06F 12/0808; G06F 12/0866
USPC 711/113

(57) ABSTRACT

Aspects of the disclosure pertain to a system and method for versioning cache for a clustered topology. In the clustered topology, a first controller mirrors write data from a cache of the first controller to a cache of the second controller. When communication between controllers of the topology is disrupted (e.g., when the second controller goes offline, while the first controller stays online), the first controller increments a cache version number stored in a disk data format of a logical disk, the logical disk being owned by the first controller and associated with the write data. The incremented cache version number provides an indication to the second controller that the data of the cache of the second controller is stale.

### CROSS-REFERENCE TO RELATED APPLICATIONS

This application claims priority to U.S. Provisional Application No. 61/842,196 filed on Jul. 2, 2013, entitled: “System and Method of Versioning Cache for a Clustered Topology”, which is hereby incorporated by reference in its entirety.

### FIELD OF THE INVENTION

The present disclosure relates to the field of electronic data handling and particularly to a system and method of versioning cache for a clustered topology.

### BACKGROUND

In clustered topologies, two or more controllers have copies of cache data. This raises conditions where one controller's data is possibly obsolete, such as when communication fails between the controllers and temporarily prevents mirroring of cache from one controller to another.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner

Aspects of the disclosure pertain to a system and method for versioning cache for a clustered topology.

### DESCRIPTION OF THE FIGURES

The detailed description is described with reference to the accompanying figures:

FIG. 1 is an example conceptual block diagram schematic of a clustered topology system in accordance with an exemplary embodiment of the present disclosure; and

FIG. 2 is a flow chart illustrating a method of operation of the system shown in FIG. 1, in accordance with an exemplary embodiment of the present disclosure.

### WRITTEN DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

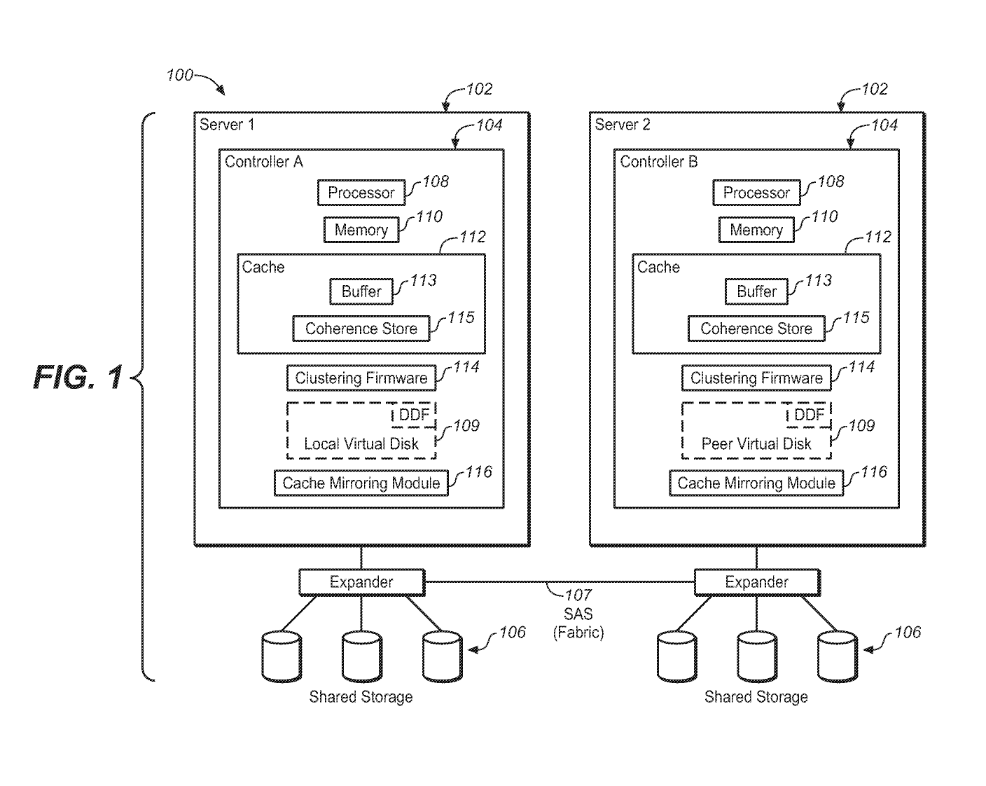

Referring to FIG. 1 (FIG. 1), a system 100 in accordance with an exemplary embodiment of the present disclosure is shown. In embodiments, the system 100 is a clustered topology. In embodiments, the system 100 includes a plurality of servers (e.g., nodes, server nodes, computer systems, host nodes) 102. In embodiments, each of the servers 102 includes a storage controller (e.g., initiator) 104. For instance, the storage controllers 104 are Redundant Array of Independent Disks (RAID) controllers (e.g., MegaRAID® storage controllers).

In embodiments, the system 100 includes a storage pool including a plurality of data storage devices (e.g., hard disk drives (HDDs), solid-state drives (SSDs) 106. In embodiments, each of the storage controllers 104 are connected to the storage pool of drives 106. For example, the storage controllers 104 are connected to the drives 106 via a fabric 107, such as a serial-attached small computer systems interface (SAS) fabric. In embodiments, the system 100 implements RAID and the plurality of disk drives 106 is a RAID array. In embodiments, RAID is a storage technology that combines multiple disk drive components (e.g., combines the disk drives 106) into a logical unit. In embodiments, data is distributed across the drives 106 in one of several ways, depending on the level of redundancy and performance required. In embodiments, RAID is computer data storage scheme that divides and replicates data among multiple physical drives (e.g., the disk drives 106). In embodiments, RAID is an example of storage virtualization and the array (e.g., the disk drives 106) can be accessed by an operating system as a single drive (e.g., a logical disk (LD), a logical drive, a virtual disk (VD), a virtual drive) 109. In embodiments, virtual disks 109 from RAID arrays 106 can be either private or shared among the controllers 104. For shared storage, each of the server nodes 102 has access to the virtual disks 109. In the shared storage fabric, the controllers 104 work together to achieve storage sharing, cache coherency and redundancy. The controllers 104 are linked on the SAS fabric 107 and share common protocols for exchanging information and controls. One set of protocols allows the controllers 104 to exchange shared storage virtual disks 109, enabling each controller 104 to reserve resources and export these virtual disks 109 to their respective host servers 102. Other protocols exist for heartbeat, failover, cache mirroring, and so on.

In embodiments, the controllers (e.g., disk array controllers) 104 are configured for managing the physical disk drives 106. In embodiments, the controllers 104 are configured for presenting the physical disk drives 106 to the servers 102 as logical units. In embodiments, the controllers 104 each include a processor 108. In embodiments, the controllers 104 each include memory 110. In embodiments, the processor 108 of the controller 104 is connected to (e.g., communicatively coupled with) the memory 110 of the controller 104. In embodiments, the processor 108 is hardware which carries out the instructions of computer program(s) by performing basic arithmetical, logical and input/output operations. In embodiments, the processor 108 is a multi-purpose, programmable device that accepts digital data as an input, processes the digital data according to instructions stored in the memory 110, and provides results as an output. In embodiments, the memory 110 of the controllers 104 is or includes cache 112 (e.g., write back (WB) cache). In embodiments, the write back cache 112 includes cache buffers 113 and cache coherency store 115

In embodiments, each storage controller 104 presents the same storage volumes from the pool of drives (e.g., shared storage) 106 to each server node 102. In embodiments, each server node 102 accesses the shared storage 106, such as via write commands and read commands (e.g., small computer systems interface (SCSI) read and write commands).

In embodiments, the storage volumes presented to the servers 102 are RAID storage volumes. For example, the RAID storage volumes can be of any RAID type, including RAID 5 or RAID 6. In embodiments, the storage controllers 104 are configured for maintaining data/parity consistency. Maintaining consistency means that the controllers 104 address all write-hole conditions, including failover, when a RAID 5 or RAID 6 virtual disk (VD) is in degraded mode. To provide robustness and simplicity, the disks 106 associated with a virtual disk 109 are only accessed by a single controller 104 at any given time. The controller 104 that has access is essentially the owner of the virtual disk 109 (and of the disk group associated with the virtual disk). The non-owning controller 104 does not have visibility to the disks and has only an indirect view of the disks 106 and the associated virtual disk (VD) 109 through the owning controller. In embodiments, disk ownership changes from one controller 104 to the other during planned or unplanned failover, which also involves issuing requests to a reservation manager to transfer the ownership.

In embodiments, the storage controllers 104 operate in write back cache mode to maintain data cache coherency. The storage servers 102 are configured for relying on the write back cache 112 for performance and coherency. To support cache coherency even in controller failure or node failures, the MegaRAID® controllers 104 keep a second copy of all host write data until the data is committed to the storage media 106. In a two-node configuration, all cache data and related metadata are mirrored to the partner controller 104 before the command (e.g., input/output (I/O) command) is completed to the host 102. In embodiments, cache mirroring is done over the SAS link 107 between the controllers 104.

In embodiments, multiple virtual disks (VDs) 109 are created from a given array 106, and each virtual disk represents a logical unit number (LUN) to the storage server. There is no limitation on how the storage server assigns or reserves the LUNs. In embodiments, the storage controllers 104 are configured for supporting SCSI-3 Persistent Reservation (PR) protocol, which is used to arbitrate for access to disks. For example, SCSI-3 PR protocol is used to enforce exclusive access to disks. In embodiments, because virtual disks 109 are shared between the controllers 104, two types of virtual disks 109 are supported by the system 100: local virtual disks (which are created from the disk group owned by the local controller 104); and remote virtual disks (in which the virtual disks are from the disk group owned by the other controller 104). Because the local controller 104 cannot directly access remote virtual disks, input/output requests (e.g., read requests, write requests) to a remote virtual disk are shipped to the owning controller 104 by sending them to the remote controller 104 over the SAS fabric 107. Data for the I/O request is also transferred between the controllers 104 via the SAS 107. Thus, when a host request is sent to the controller 104, and the request is to a remote virtual disk, this request is shipped to the appropriate controller to process the I/O. I/O shipping can be accelerated via a FastPath feature. FastPath has two high-level benefits. First, no extra latency is incurred in processing the request in firmware 114 (e.g., MegaRAID® firmware) of the controllers 104 and creating a child I/O to forward to the peer controller 104. Second, I/O processing on the I/O shipping node is avoided, which lowers central processing unit (CPU) utilization and frees that CPU for other tasks. MegaRAID® firmware 114 is not designed to share virtual disks 109, or even devices, between initiators 104. In fact, the firmware 114 implicitly assumes control of all devices it finds during SAS and device discovery. To accommodate the sharing of storage and still preserve many of the inherent MegaRAID® firmware assumptions, several technologies, including device fencing (e.g., via SCSI-3 PR), controller sharing and syncing, and I/O shipping. In further embodiments, any one of a number of various bus protocols other than SAS may be used to perform mirroring and/or I/O shipping. For example, a Peripheral Component Interconnect Express (PCIE) link may be implemented for performing mirroring and/or I/O shipping.

In the cluster topology 100, failover from one node 102 to the other can occur at any time. Clustering firmware 114 supports a planned failover, in which a user or administrator of the system 100 intentionally moves the ownership of the storage volume. The clustering firmware 114 also supports unplanned failover, in which a server node 102 experiences some type of failure and the cluster software initiates failover on its own. In embodiments, for RAID 5 and RAID 6 virtual disks, the controllers 104 support write-hole protection by mirroring the parity before each partial stripe update is done to the storage media 106. Mirroring of parity data is similar to mirroring of write data and uses the same facilities. The firmware 114 also mirrors write journal entries that correspond to the parity and write data

In embodiments, in the clustered topology 100, the multiple controllers 104 are configured for providing redundancy. In the event that one of the controllers 104 fails or loses power, another of the controllers 104 is configured for bringing logical drives (e.g., logical disks, virtual disks, virtual drives) 109 associated with (e.g., owned by) the failing controller 104 online such that the server nodes 102 are able to maintain access to storage 106.

In embodiments, the controllers (e.g., MegaRAID® controllers) 104 use write back cache 112 for accelerating I/O performance. Write back cache 112 includes dirty data from one or more host nodes 102. In order for peer nodes (e.g., host nodes 102, storage controllers 104) to bring logical drive(s) 109 online following failover, any write back cache content must also be available. The controllers 104 implement cache mirroring to ensure that peer controllers 104 have a mirror of dirty data present in cache 112 in case failover occurs.

In embodiments, cache mirroring is implemented by the system 100 for write back support, as well as for RAID 5 and RAID 6 write-hole protection. Write-back cache data and RAID 5 and RAID 6 parity are mirrored to a partner controller 104 to preserve coherency across node failures or controller failures. Write journal entries are also mirrored to ensure proper write-hole protection. In embodiments, to maintain data coherency, the cache mirroring module 116 mirrors all dirty cache data (including dirty parity) and write journal entries to a peer node (e.g., peer server 102, peer controller 104) before the data and entries are validated locally. The dirty cache data applies to all RAID levels and is independent of the data's source (e.g., host, peer, internal). Further, for RAID 5 and RAID 6, parity data is also mirrored as part of the journaling.

In embodiments, to avoid the RAID 5 write hole, journal entries for SAS writes are mirrored to the peer node (102, 104). This process ensures that the peer controller 104 is aware of interim states in which a row is not coherent on a disk 106 because one or more writes to a row (e.g., data +parity) are not yet complete. When failover occurs, the peer node 104 flushes the journaled writes. In embodiments, the cache mirroring module 116 protects the mirrored cache 112 when a power loss occurs. That is, the recipient of mirrored cache lines (e.g., peer controller 104) is configured for bringing a virtual disk 109 online and flushing the mirrored data in the peer controller cache 112 following a power loss. The protection mechanism recognizes stale data in the cache 112 of the peer controller 104 and discards it if the peer controller (e.g., peer node) 104 already has the specified virtual disk 109 online. The protection mechanism is compatible with pinned cache. Pinned cache is dirty cache that the controller 104 preserves when a virtual disk 109 goes offline, is unavailable (e.g., missing), and/or is deleted because of missing physical disks 106. The controller 104 might not be able to reconfigure the cache structures as a result of pinned cache. The cache mirroring module 116 recognizes and handles this case by notifying the user to bring disks 109 online or by allowing the user to discard the cache data. Pinned cache is dirty cache that the controller 104 preserves when a virtual disk 109 goes offline or is deleted because of missing physical disks 106. To prevent data loss in such situations, the firmware 114 preserves the pinned cache until the user can recover the virtual drives or until the user explicitly requests that the pinned cache be discarded. If the pinned cache is in memory that is not battery backed, the pinned cache is lost if the power fails. After the virtual drives are back online, the lost data is available from the pinned cache, if there is any. If pinned cache is present, creation of virtual drives 109 is not allowed. Background operations such as rebuild and construction, battery relearn operations, and patrol read are stopped if there is pinned cache.

In embodiments, the fact that two or more controllers 104 have copies of the cache data raises conditions where one controller's data is possibly obsolete. For example, there may be two controllers 104 (e.g., controller A and controller B) and a single logical disk 109, where controller A owns the logical disk 109 and is mirroring writes to controller B. If communication fails between controller A and controller B, resulting in controller A being unable to mirror a given dirty cache line to the peer (e.g., controller B), then allowing controller A to proceed to act on that cache line would create potential data corruption issues. For example, assuming the following scenario: controller B was powered off, thereby creating the communication failure; then, controller A continues running for minutes/hours/days and then loses power; then, controller B boots up and attempts to bring the logical disk 109 owned by controller A online; and at the time controller B was powered off, controller B had dirty cache. Based on that scenario, controller B may attempt to flush its (e.g., controller B's) cache 112, even though the data in the cache 112 of controller B is quite stale.

To prevent the above scenario, the controllers 104 of the system 100 described herein are configured for recognizing when dirty data in their cache 112 is valid and/or not valid. In order to bring logical disk(s) associated with a failing/failed controller online without potential for data corruption, a method is established herein to determine if content of the cache 112 of the controller(s) 104 is valid. The method described herein also determines whether a currently unavailable controller 104 has newer cache (e.g., cache data) that must be retrieved before the logical disk(s) 109 associated with that controller 104 can be brought online In embodiments, the system/method described herein implements versioning of cache data. In embodiments, this cache version number is on a per LD basis since LDs 109 can come and go independent of one another. In embodiments, a cache versioning algorithm is implemented for providing the above-referenced functionality. The cache versioning algorithm offers a mechanism for detecting and reconciling cases where multiple initiators in a topology have snapshots of a write back cache 112 from different points in time. This mechanism is necessary to allow write back caching to be enabled without the possibility of data corruption following failover.

Further, virtual disks (e.g., logical disks) 109 (and to some extent, target IDs) are not persistent, so in the system 100 disclosed herein, the cache version number is associated with the virtual drive globally unique identifier (VD GUID) (e.g., logical drive globally unique identifier (LD GUID). This arrangement ensures that firmware 114 can later associate the cache data with the correct (e.g., exact) virtual disk/logical disk when it is found again. To completely guard against data corruption, the remaining controller 104 (e.g., controller A in the example discussed above) increments the version number whenever it is unable to mirror a cache line, completely invalidating the peer controller's mirror cache for that virtual disk/logical disk 109. The remaining controller (e.g., controller A) must commit the version number increment before it allows any new lines to transition to the dirty state and/or before it allows any write journal entries to be created. This ensures that host commands are not completed until the controller 104 either mirrors the data successfully or stale peer data is marked obsolete. Peer-to-peer communication is not a sufficiently reliable method to communicate the version number increment, because peers (e.g., peer controllers 104) might not be able to communicate with one another. Possible causes include split brain topology or the previous example in which controller B loses power and controller A is unavailable when power is restored. As a result, the version number is stored in disk data format (DDF) of the virtual disk(s) 109. In embodiments, DDF is a disk metadata format used to describe RAID groups. DDF also allows for vendor-unique metadata sections where controller-specific data, such as the cache version, can be stored. Further, it is contemplated that any proprietary method can be used to establish a GUID as long as it is unique to a logical drive (LD) or virtual drive (VD). In embodiments, the GUID is created/assigned at the time of LD/VD creation and follows the LD/VD until it is deleted. In embodiments, following the LD/VD until it is deleted can be achieved by storing the GUID in LD/VD metadata on the physical disks. This ensures that initiators which have never been exposed to this LD/VD can bring the LD/VD online while still maintaining the GUID.

In the 2-node cache mirroring example described above, assuming that both controllers 104 sync up in an initial state where no data has been mirrored, both controllers start with a cache generation (e.g., cache version) number of 1. The cache generation number does not change during normal operations and planned failovers. The cache generation number (e.g., generation code, version number code) is also written to DDF. Along with the version number code, a dirtyCachePresent bit is recorded in the DDF. A value of 0 for this bit indicates that the virtual disk/logical disk 109 was shut down cleanly, with all data flushed to disk (106, 109). If any node (e.g., controller 104) has residual cache data for that virtual disk/logical disk 109, it can discard that data.

In embodiments, if when a controller 104 initializes, it determines that it was shut down abruptly (e.g., that is, due to a crash or a power loss) and has data in the cache 112 and/or cache mirror 112, the controller 104 determines if it should replay or flush the data in its cache buffers 113 and cache coherency store 115 to the disks (106, 109). The controller 104 uses the cache version (e.g., cache version number, version number) and the dirtyCachePresent bit (e.g., dirtyCacheData) in the DDF and compares these with the one(s) in its own memory 110. The copies in memory 110 describe the version of the cache data in that controller's memory. The copies in DDF describe the current version of the disk (106, 109). If a peer controller 104 continued to run after this controller crashed, it would have incremented the cache version to effectively mark this controller's cache 112 as stale. A dirtyCachePresent bit value equal to 1 in the DDF indicates that the virtual disk/logical disk 109 was not cleanly shut down and dirty cache is likely present on one or both controllers 104. A dirtyCachePresent bit value equal to 0 indicates that cache data was flushed to disk (106, 109) and a clean shutdown sequence is performed. If a node boots and determines that it has dirty cache contents, yet the DDF of the virtual disk/logical disk 109 indicates a dirtyCachePresent bit value equal to 0, the node 104 discards the cache contents because the dirtyCachePresent bit value indicates that the peer controller 104 survived and continued on with this virtual disk/logical disk 109 to eventually perform a clean shutdown. If the value of the dirtyCachePresent bit in the DDF is equal to 1 and the cache version code stored in the memory 110 and the DDF match, the controller 104 determines that the data in the cache 112 is valid, and it can flush the cache 112 to disk (106, 109). However, if the cache version code (e.g., cache version) in the memory 110 and the DDF do not match, the data in the cache 112 is not valid, and is discarded, and the controller 104 brings the virtual disk/logical disk 109 online in a blocked state and waits for one of the following conditions: a.) the peer controller 104 boots, takes over the virtual disk/logical disk 109, and flushes the cache 112 assuming that the cache version matches; b.) the user manually transitions the virtual disk access policy/logical disk access policy from blocked to read/write (by doing this, the user acknowledges the cache data loss and forces the virtual disk/logical disk 109 back into operation, this step might be necessary if the user does not have a backup).

Cache mirroring will use the following algorithm.
1. Store the following in DDF:
   a. Store cache version as U32 on per LD basis. U32 is a 32-bit value.
   b. Store dirtyCachePresent on a per LD basis. This bit will indicate there may be dirty cache present (we won't necessary write DDF every time we flush the cache as part of normal eviction).
2. Store the following in memory. Both of these must be on a per LD basis. These values should have the same persistency as the data cache. These values need to have a one-to-one correlation to the VD/LD GUID
   a. Cache version as U32
   b. dirtyCachePresent.
3. dirtyCachePresent behavior:
   dirtyCachePresent may be cleared anytime the cache transitions to clean state (no remaining dirty lines). However, updating the dirtyCachePresent frequently can incur performance penalties due to the disk activity required to perform DDF updates. Therefore, clearing of dirtyCachePresent can be reduced to cases where the cache is explicitly flushed. Some examples of this are:
   a. complete cache flush when the VD/LD is brought online (typically during boot)
   b. during a graceful system shutdown, the operating system first flushes its cache and then signals controllers, VDs to flush their caches in order to prepare for power down
   c. cache flush request generated by user or operating system driver through proprietary controller interface
4. Cache version behavior:
   a. When cache mirroring is brought online, the controllers synchronize and establish a common cache version for each LD
   b. Increment cache version whenever failure to mirror dirty data/parity occurs.
      i. Only increment on the first IO which the controller is unable to mirror in a given boot cycle. This is to prevent the cache version from wrapping.
         1. Will have to do so once per boot if peer is unavailable because the controller doesn't track peer's cache version.
      ii. After incrementing cache version, solutions can choose to switch VD/LD to Write Through mode. This minimizes the generation of dirty cache data. Additionally, on RAID 0, RAID 1, RAID 10 VDs/LDs, dirtyCachePresent can be cleared after any outstanding cache is flushed. Clearing dirtyCachePresent ensures that the VD/LD can subsequently be brought online by VD/LD if a failure or power loss were to occur. RAID 5 and RAID 6 cannot benefit from this because write journals are required to protect against the write hole and dirtyCachePresent must be “1”, whenever write journal entries are outstanding.
         1. If LD is R0, R1, R10 when flush completes clear the dirtyCachePresent. This allows subsequent failovers to occur on this LD
      iii. During a flush following system or controller boot, RAID 0 or RAID 1 LDs do not need to increment the cache version if the controller is unable to mirror flush or invalidate operations. This would allow a peer with the same cache version to take over if the flush operation is interrupted.
      This same logic cannot be applied to RAID 5 or RAID 6 VDs due to the write hole problem. Instead, dirtyCachePresent must be incremented anytime the controller is unable to mirror a flush or invalidate operation.
   c. Cache version must always be restored from DDF . . . even if no dirty cache was present. This prevents reverting to an earlier cache version which may happen to match a peer's data version.
5. Foreign import and local LD boot behavior changes:
   a. If LD has dirtyCachePresent(DDF)==0 then perform the following:
      i. Discard any local cache associated with that LD. The bit indicates it was shutdown cleanly so local data is stale/unnecessary.
      ii. Import the LD normally.
      iii. Update cacheVersion(local) to cacheVersion(DDF)
   b. If LD has dirtyCachePresent(DDF)==1 then perform the following:
      i. If cacheVersion(DDF)==cacheVersion(local) continue import normally.
      ii. import the VD into a blocked state where host requests to read and write to the VD are rejected. Represent the blocked state to the user through proprietary controller interface. Provide mechanism through controller interface where user may transition the VD to unblocked state after acknowledging that cache data will be lost.
6. When booting local controller with dirtyCachePresent(local) is 1 and remote LDs are present, perform the following:
   i. Fetch the LD cacheVersions(peer,ddf) and dirtyCachePresent(peer,ddf).
      1. If LD has dirtyCachePresent(ddf)=0 then discard local cache data.
      2. If configuration indicates local controller has valid cache version and peer controller did not have valid cache version then the controller needs to move the LD to this node. This will allow the local controller to import and flush cache.
         a. This case is detected when the following are all true:
         i. dirtyCachePresent(local)=1
         ii. dirtyCachePresent(ddf)=1
         iii. cacheVersion(local) is equal to to cacheVersion(ddf)
         iv. cacheVersion(peer)! is equal to cacheVersion(ddf)
      3. If the LD dirtyCachePresent(ddf)=1 and cacheVersion(local)!=cacheVersion(ddf) then a peer node had incremented the cache version of this LD after the local node became unavailable. Perform the following:
         a. discard the local cache data for that LD
         b. clear dirtyCachePresent(local)

### RAID 5/6 Write Hole

In embodiments, RAID 5/6 partial strip updates involve several synchronized steps to accomplish in order to maintain data integrity. If during a partial stripe update the controller 104 is interrupted, such as due to a node 102 or controller 104 failure, this could produce inconsistent stripes (parity does not match data), or even corrupted data in the case of a degraded array 106. In order to resolve the write-hole problem for a degraded RAID 5/6, both the data and parity need to be accessible by the failover controller 104 in order to fix the stripes that were partially updated. In a 2-node configuration, the data and parity is mirrored to the partner controller 104, so that, even after a node failure, the partner controller 104 can recover the stripes. Write journal entries are also mirrored to ensure proper data is flushed to disk (106, 109) in the case where a power interruption occurs.

### Exemplary Processes

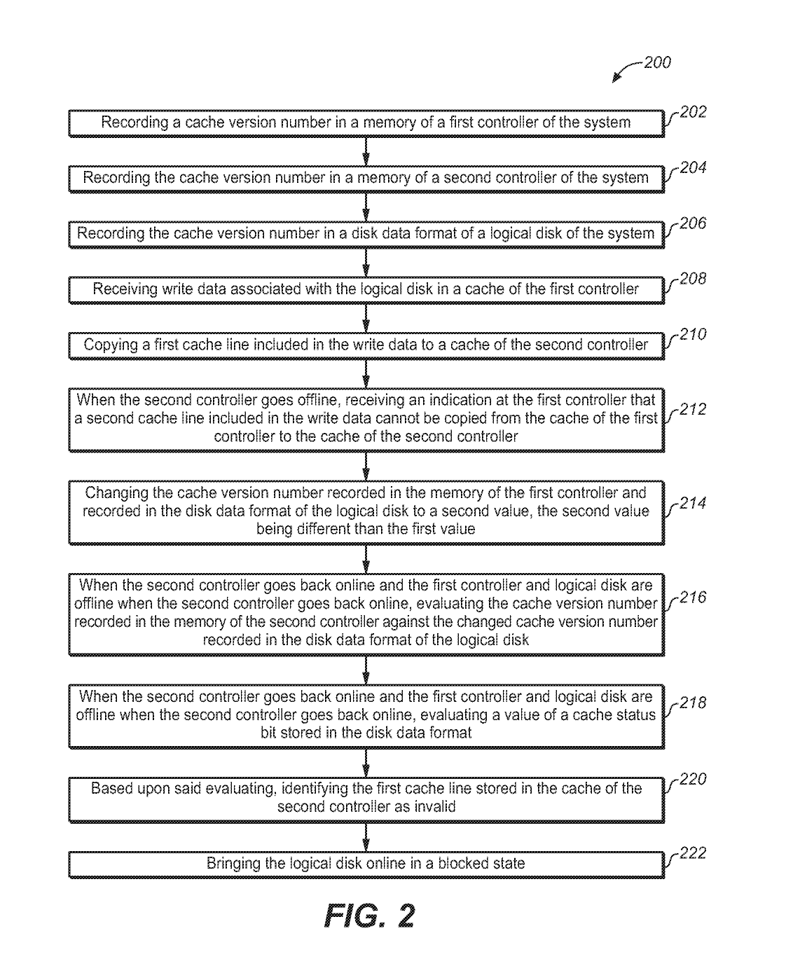

Referring to FIG. 2 (FIG. 2), a flowchart illustrating a method of operation of the system 100 shown in FIG. 1 in accordance with an exemplary embodiment of the present disclosure is shown. In embodiments, the method 200 includes a step of recording a cache version number in a memory of a first controller of the system (Step 202). For example, the first controller 104 records and stores a cache version number in memory 110 of the first controller 104. In embodiments, the method 200 further includes a step of recording the cache version number in a memory of a second controller of the system (Step 204). For example, the second controller 104 records and stores the cache version number in memory 110 of the second controller 104.

In embodiments, the method 200 further includes a step of recording the cache version number in a disk data format of a logical disk of the system (Step 206). For example, the first controller 104 owns the logical disk 109 and records and stores the cache version number (which is associated with the logical disk 109 and is a first value) in the disk data format of the logical disk 109. In embodiments, the method 200 further includes a step of receiving write data associated with the logical disk in a cache of the first controller (Step 208). For example, host write data associated with the logical disk 109 is received by the cache 112 of the first controller 102.

In embodiments, the method 200 further includes a step of copying a first cache line included in the write data to a cache of the second controller (Step 210). For example, the first controller 104 copies (e.g., mirrors) the first cache line of the write data in its cache 112 to the cache 112 of the second controller 104. In embodiments, the method 200 further includes a step of, when the second controller goes offline, receiving an indication at the first controller that a second cache line included in the write data cannot be copied from the cache of the first controller to the cache of the second controller (Step 212).

In embodiments, the method 200 further includes a step of changing the cache version number recorded in the memory of the first controller and recorded in the disk data format of the logical disk to a second value, the second value being different than the first value (Step 214). For example, the first controller 104 is configured for changing/updating/incrementing the cache version number recorded in memory 110 of the first controller 104 and recorded in the disk data format of the logical disk 109 to a second/different value. In embodiments, the method 200 further includes a step of, when the second controller goes back online and the first controller and logical disk are offline when (e.g., at the time) the second controller goes back online, evaluating the cache version number recorded in the memory of the second controller against the changed cache version number recorded in the disk data format of the logical disk and evaluating a cache status bit recorded in the disk data format (Steps 216 and 218). For example, the second controller 104 boots up (e.g., goes back online), determines that the first controller 104 is now offline, and evaluates the cached version number recorded and stored in memory 110 of the second controller 104 against the changed cache version number recorded/stored in the disk data format of the logical disk 109.

In embodiments, the method 200 further includes a step of, based upon said evaluating, identifying the first cache line stored in the cache of the second controller as invalid (Step 220). For example, based upon the evaluation, the second controller 104 identifies that the cache version number stored in memory 110 of the second controller 104 is different from that stored in the disk data format, which provides an indication that the data in the cache 112 of the second controller 104 is stale. In embodiments, the method 200 further includes the step of bringing the logical disk online in a blocked state (Step 222).

It is to be noted that the foregoing described embodiments may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the embodiments described herein may be conveniently implemented in forms of a software package. Such a software package may be a computer program product which employs a non-transitory computer-readable storage medium including stored computer code which is used to program a computer to perform the disclosed functions and processes disclosed herein. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of operation of a system, the method comprising:
recording a cache version number in a memory of a first controller of the system;
recording the cache version number in a memory of a second controller of the system;
recording the cache version number in a disk data format of a logical disk of the system; and
receiving write data associated with the logical disk in a cache of the first controller,
wherein the logical disk is owned by the first controller, the cache version number being associated with the logical disk, the cache version number being a first value.

2. The method as claimed in claim 1, further comprising:
copying a first cache line included in the write data to a cache of the second controller.

3. The method as claimed in claim 2, further comprising:
when the second controller goes offline, receiving an indication at the first controller that a second cache line included in the write data cannot be copied from the cache of the first controller to the cache of the second controller.

4. The method as claimed in claim 3, further comprising:
changing the cache version number recorded in the memory of the first controller and recorded in the disk data format of the logical disk to a second value, the second value being different than the first value.

5. The method as claimed in claim 4, further comprising:
when the second controller goes back online and the first controller and logical disk are offline when the second controller goes back online, evaluating the cache version number recorded in the memory of the second controller against the changed cache version number recorded in the disk data format of the logical disk.

6. The method as claimed in claim 5, further comprising:
when the second controller goes back online and the first controller and logical disk are offline when the second controller goes back online, evaluating a value of a cache status bit stored in the disk data format.

7. The method as claimed in claim 6, further comprising:
based upon said evaluating, identifying the first cache line stored in the cache of the second controller as invalid.

8. The method as claimed in claim 7, further comprising:
bringing the logical disk online in a blocked state.

9. A non-transitory computer-readable medium having computer-executable instructions for performing a method of operation of a system, the method comprising:
recording a cache version number in a memory of a first controller of the system;
recording the cache version number in a memory of a second controller of the system;
recording the cache version number in a disk data format of a logical disk of the system; and
receiving write data associated with the logical disk in a cache of the first controller,
wherein the logical disk is owned by the first controller, the cache version number being associated with the logical disk, the cache version number being a first value.

10. The non-transitory computer-readable medium as claimed in claim 9, the method further comprising:
copying a first cache line included in the write data to a cache of the second controller.

11. The non-transitory computer-readable medium as claimed in claim 10, the method further comprising:
when the second controller goes offline, receiving an indication at the first controller that a second cache line included in the write data cannot be copied from the cache of the first controller to the cache of the second controller.

12. The non-transitory computer-readable medium as claimed in claim 11, the method further comprising:
changing the cache version number recorded in the memory of the first controller and recorded in the disk data format of the logical disk to a second value, the second value being different than the first value.

13. The non-transitory computer-readable medium as claimed in claim 12, the method further comprising:
when the second controller goes back online and the first controller and logical disk are offline when the second controller goes back online, evaluating the cache version number recorded in the memory of the second controller against the changed cache version number recorded in the disk data format of the logical disk.

14. The non-transitory computer-readable medium as claimed in claim 13, the method further comprising:
when the second controller goes back online and the first controller and logical disk are offline when the second controller goes back online, evaluating a value of a cache status bit stored in the disk data format.

15. The non-transitory computer-readable medium as claimed in claim 14, the method further comprising:
based upon said evaluating, identifying the first cache line stored in the cache of the second controller as invalid.

16. The non-transitory computer-readable medium as claimed in claim 15, the method further comprising:
bringing the logical disk online in a blocked state.

17. A clustered topology system, comprising:
a storage array;
a first storage controller, the first storage controller being connected to the storage array, the first storage controller configured for receiving host write data in a write back cache of the first storage controller, the host write data being associated with a logical disk associated with the storage array, the logical disk being owned by the first storage controller, the first storage controller configured for transmitting the host write data from write back cache of the first storage controller to the storage array, the first storage controller configured for storing a cache version number in memory of the first storage controller and in a disk data format of the logical disk, the cache version number having a first value;
a second storage controller, the second storage controller being connected to the storage array, the second storage controller being connected to the first storage controller, the first storage controller configured for mirroring the host write data from the write back cache of the first storage controller to a write back cache of the second storage controller, the second storage controller configured for storing the cache version number in memory of the second storage controller
wherein, when the first storage controller is online and the second controller goes offline and the first controller is prevented from mirroring a cache line of the host write data to the second storage controller, the first storage controller is configured for changing the cache version number stored in the disk data format of the logical disk to a second value, the second value being different than the first value.

18. The system as claimed in claim 19, wherein, when the second storage controller goes back online while the first storage controller is offline, the second storage controller is configured for evaluating the cache version number stored in memory of the second storage controller against the changed cache version number and a cache status bit stored in the disk data format of the logical disk, and handling write data present in the cache of the second storage controller based upon said evaluating.

19. The system as claimed in claim 17, wherein the first and second storage controllers are Redundant Array of Independent Disks storage controllers.

20. The system as claimed in claim 17, wherein the first storage controller is communicatively coupled with the second storage controller via a serial-attached small computer systems interface fabric.
